(19) United States
(12) Patent Application Publication
(10) Pub. No.: US 2026/0352139 A1
(43) Pub. Date: Nov. 5, 2026

(54) PORTABLE ENERGY PRODUCTION AND STORAGE DEVICE

(71) Applicant: Tommaso MILONE, Genova (IT)

(72) Inventor: Tommaso MILONE, Genova (IT)

(21) Appl. No.: 19/482,795

(22) PCT Filed: May 8, 2024
(86) PCT No.: PCT/IB2024/054491

§ 371 Date: Nov. 10, 2025

(30) Foreign Application Priority Data
May 8, 2023 (IT) 102023000009174

(51) Int. Cl. H02S 10/40; H02S 20/32; H02S 30/20; H02S 40/32; H02S 40/38

(52) U.S. Cl. CPC H02S 10/40; H02S 20/32; H02S 30/20; H02S 40/32; H02S 40/38

(57) ABSTRACT

The present invention is within the scope of portable devices for the production and storage of renewable energy.

In particular, this invention relates to the production of photovoltaic energy on the move.

Power stations have been created that can be connected to external photovoltaic panels, often sold in folding or resealable kits that, if necessary, can be connected to the power station for “off grid” charging, although it is not a “native” solution. This solution is however rather disadvantageous for a number of reasons which will be explained in the text and will be solved by the present invention.

### SCOPE OF THE INVENTION

The present invention is within the scope of portable devices for the production and storage of renewable energy.

In particular, this invention relates to the production of photovoltaic energy on the move.

### STATE OF THE ART

On the market today there are several solutions that aim to give a user the possibility of having a portable energy source that can power objects of common use, for example the so-called “power stations” on the market in a wide range of types, powers, and sizes, up to more structured solutions that can power loads of greater importance. All these embodiments always include at least one battery (or battery pack) connected or not to at least one inverter to supply current at different voltages. The battery is then recharged, by means of a battery charger, taking current from the domestic network for example and then disposing of it anywhere.

Disadvantageously, when the battery runs out, in order to be able to have a new charge again, it will be necessary to connect to the electricity grid which, if you are in isolated environments or in any case not served by this service, these power stations will be unusable. To partly overcome this problem, power stations have been created that can be connected to external photovoltaic panels, often sold in folding or resealable kits that, if necessary, can be connected to the power station for “off grid” charging, although it is not a “native” solution. However, this solution is rather disadvantageous since the connected panels will have to be stored separately for transport (note that we are talking about portable solutions, therefore necessarily subject to transport), all this with the problem of having to necessarily manage several elements separated from each other and each time prepare the connections between them in order to put the battery and panel system into operation, also having to consider for the correct and functional positioning of the panels, a series of supports that even in relation to the roughness of the ground, are not easy to position, this complicating not a little the operations of commissioning the power station and ultimately, but of fundamental importance, this positioning will be disadvantageously fixed, therefore not optimizable with respect to the position of the sun if the orientation of the photovoltaic panels is not continuously changed by hand, with great loss of time, for a complex and extremely binding operation.

An object of the present invention is therefore to describe a portable energy production and storage device that can be compact and transportable in a single container.

A further object of the present invention is to describe a portable energy production and storage device that can autonomously optimize the exposure of the photovoltaic panels included therein in relation to the position of the sun.

Another object of the present invention is to describe a portable energy production and storage device that can be modular and scalable, i.e. that can be expanded (or reduced) at will according to the demand for electrical power necessary for the purpose and that can be adapted to various types of use such as domestic, corporate, industrial, drone, camping/motorhome, outdoor, rescue operations.

It is also an object of the present invention to describe a portable energy production and storage device that can be controlled remotely also with a visual supervision of its positioning.

An object of the present invention is also to describe a portable energy production and storage device that can be transported without the need for water protection.

Yet another object of the present invention is to describe a portable energy production and storage device that can remunerate in digital currency the energy produced without carbon production.

### BRIEF DESCRIPTION OF THE INVENTION

These and other objects will be achieved thanks to the innovative portable energy production and storage device comprising at least one container comprising at least one inverter, at least one solar charge regulator, at least one battery and characterized in that it further comprises inside said container, photovoltaic panels for recharging said batteries, guides, brackets and/or extractable and/or removable supports to house said panels once extracted from said container to be exposed to the sun.

Said portable energy production and storage device further comprising inside said container at least one control board and outside it in a lower part motorized wheels, at least one traction motor on at least one of said wheels, said control board being connected to said at least one inverter, to at least one solar charge regulator, to at least one battery to monitor at least the electricity production parameters, said control board being further connected to at least one traction motor to be able to operate said traction motor in order to move said container in a position of maximum production of photovoltaic energy or keeping the photovoltaic panels always facing the sun.

Said control board further comprising a radio interface to be able to connect via technology e.g. WIFI, bluetooth, BLE, LTE, GSM, satellite to a terminal such as a smartphone for monitoring said electrical production parameters.

Said container comprising at least one camera facing its outer surface, said video camera being connected to said control board in order to be able to visually monitor the place where said portable energy production and storage device is positioned.

Said control board further comprising GPS localization means to be able to send the position of said container also to a remote user.

Said container comprising in an external side at least one common port, for connecting to further portable energy production and storage devices to increase the electrical power of production and storage and/or to connect to the cigarette lighter socket of the car, to parallel or series connection cables of external batteries.

Said container comprising gaskets and plugs suitable for sealing the openings towards the outside in order to make it resistant to water during transport or operating in the rain.

This control board comprises a meter for the energy produced that can be converted into a credit proportional to the quantity of CO2 saved.

### BRIEF DESCRIPTION OF THE FIGURES

FIGS. 1a and 1b show the innovative portable energy production and storage device in an open configuration and its connection scheme between the parts.

FIG. 2 shows the innovative portable energy production and storage device in an open configuration with the supports for the panels deployed.

FIG. 3 shows the innovative portable device for the production and storage of energy in the working position (with panels deployed and in position).

FIGS. 4a, 4b, 4c, 4d instead show the innovative portable energy production and storage device in a closed configuration, suitable for transport.

### DETAILED DESCRIPTION OF THE FIGURES

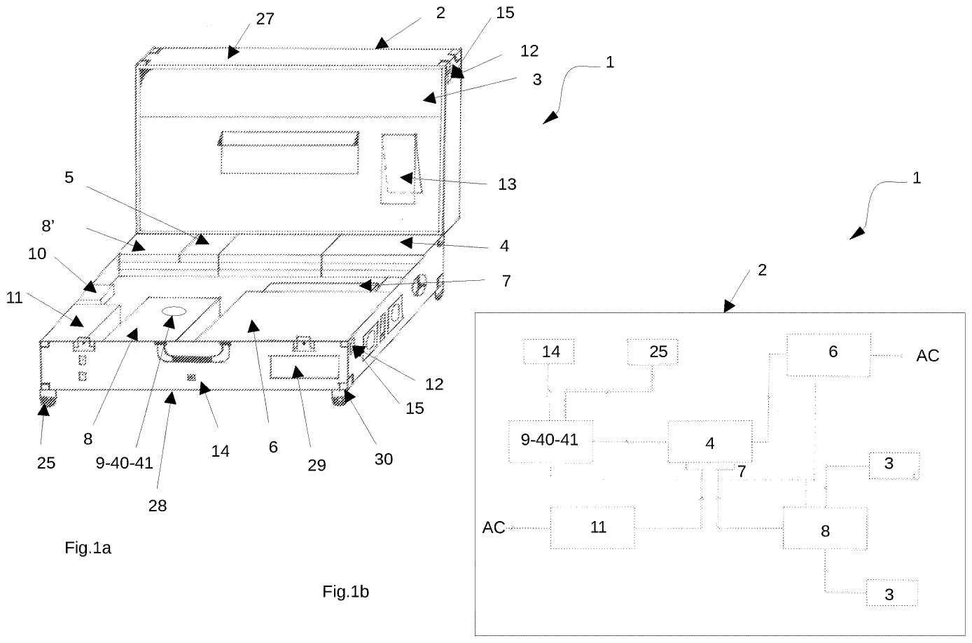

In FIGS. 1a and 1b is therefore visible the portable energy production and storage device 1 which comprises an openable container 2, in this example, and in a non-limiting way, comparable to a suitcase. Said container comprises inside photovoltaic panels 3 for example of the foldable type (but could also be rigid or flexible as long as they are suitable for the purpose). The panels are stored in an upper compartment 27, also in said upper compartment 27 there are folding brackets 13, support guides 12 and extendable supports 15, the guides are suitable for housing the extendable supports and guiding them when extracted, said supports and said brackets, as better clarified below, will support the photovoltaic panels when they are exposed to the sun. It should be noted that, in further embodiments, said brackets and supports can be contained in said container and then be extracted and positioned on it, i.e. the supports 15 can be retractable entering and exiting the container 2 through guides 12 or, for example, in an embodiment variant, the supports 15 are contained simply in the container 2 being able to be connected, for example, in the outward facing area of the guides 12 from where, in the first case, the extendable supports 15 can exit; in this case, a suitable coupling will be provided for the purpose where said supports 15 will be connected.

In a lower compartment 28 of the container 2 are included one or more batteries (one or more battery pack cells) 4, one or more charge balancers 5, one or more inverters 6, one or more BMS (battery management systems) 7 for battery management, one or more solar charge regulators SCC 8 and 8′, a control board 9, an SSR (solid state relay) 10 to protect the SCC, a battery charger 11, one or more video cameras 14.

On the bottom of said container 2 in an external part and more particularly on the external part of said lower compartment 28, motorized wheels 25 are included, equipped with at least one traction motor 30 for the car, the orientation of said portable energy production and storage device 1 as will be better clarified below. In particular, the photovoltaic panels 3 which can be electrically connected in one or more strings and can be folded and/or compacted inside the upper compartment 27, are connected to the solar charge regulator SCC 8 which in turn is connected to the battery(s) via the BMS. Charge balancers 5 can be connected to the batteries while an SSR 10 can be connected between BMS and batteries, i.e. a device that prevents the solar panels from injecting current into the SSC in the event that the BMS turns off and does not let the current pass.

At least one inverter is connected to the batteries to transform the direct current into alternating current and a battery charger 11 to be able to recharge the batteries even from a non-photovoltaic source. An important part of the portable energy production and storage device is the control board 9 (always included or housed for example in the lower compartment 28, or in any case placed in a suitable position inside the device) is also powered by the batteries 4 and is connected via a control cable to the SSC 8, to the batteries, to the battery charger, also to the inverter, to the BMS, to the charge balancer and for example also to at least one video camera 14 and to the electric motor(s) 30 of the motorized wheels 25, the electric traction motor(s) 30 will serve to provide driving torque to the motorized wheels 25.

In essence, said control board will have several functions: manage the wheels 25, activating or deactivating the electric motor(s) 30 in relation to, for example, the value of instantaneous current produced by the photovoltaic panels 3 and/or the values detected by a photodiode 26 placed on the container that will measure the incident solar radiation on the panels; for this functionality, the control board, which can be assimilated, at least in part, for example, to a microcontroller, will read the values of instantaneous current produced by the photovoltaic panels 3 and/or the brightness detected by the photodiode 26 after which it will move the container by means of the wheels 25 and the motors 30, a container to which the photovoltaic panels will be integral in an open configuration (see following figures). The movement of the container 2 will continue until the current produced by the panels or the brightness values recorded by the photodiode are maximized.

By way of example and not limitation, the functionality, or solar tracking system may be carried out in this way:
photodiode reading and/or current input to the SCC (reading 1);
clockwise rotation (boreal hemisphere) of X degrees;
photodiode reading and/or current input to the SCC (reading 2);
if reading 2 is>reading 1, rotate again by X degrees and reading 3;
if reading 3>reading 2, rotate again until reading n<reading n-1;
return to previous position and STOP.
wait 15-30 minutes and repeat the cycle.

This is in a completely advantageous and innovative way providing maximum charging efficiency derived from the exposure of the solar panels.

A second, simpler way of implementing solar tracking could instead be represented by the possibility of setting a substantially programmed tracking by programming the microcontroller to operate the electric motor(s) every “z” time so as to rotate the portable energy production and storage device 1 by “y” degrees towards the west, for example by promoting a rotation of the portable energy production and storage device 1 by 3° every 15 minutes in a clockwise direction.

The control board 9, in addition to managing the “solar tracking” operation, also includes radio means 40 such as WIFI, Bluetooth, GSM, LTE interfaces and GPS means 41 for positioning in order to be able to connect with said radio means remotely to a network and to be able to send all the data detected to a user equipped, for example, with a smartphone and the relevant app (an example of such data could be: position of the container through the GPS means 41, orientation with respect to the sun, photovoltaic energy produced, state of charge of the batteries, connected loads, temperature and operation of the various components, etc.). A video camera 14 is also connected to the control board as mentioned, which will allow a user to remotely view the environment surrounding the innovative energy production device 1.

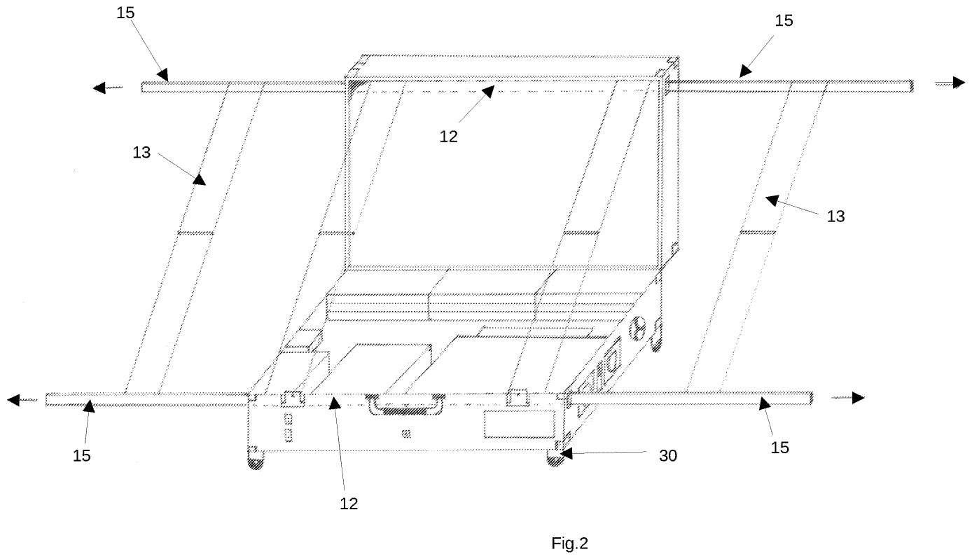

FIG. 2 shows the innovative portable energy production and storage device in a configuration with the extendable supports 15 extracted from the container 2, said extendable supports are then connected to each other by means of brackets 13 that can also be closed and folded on themselves in an exemplary embodiment. Advantageously, the extraction of the extendable supports is very simple since it is enough to extract them from their support guides 12 positioned in the upper compartment 27 of the container 2, while said brackets 13 will be fixed for example with joints, hooks, or other suitable solution for the purpose, both between the supports 15 and between the guides 12. The combination of supports, brackets and guides will constitute a support surface for the photovoltaic panels that will be fixed to it with any means suitable for the purpose (joints, Velcro, threaded connections, etc.).

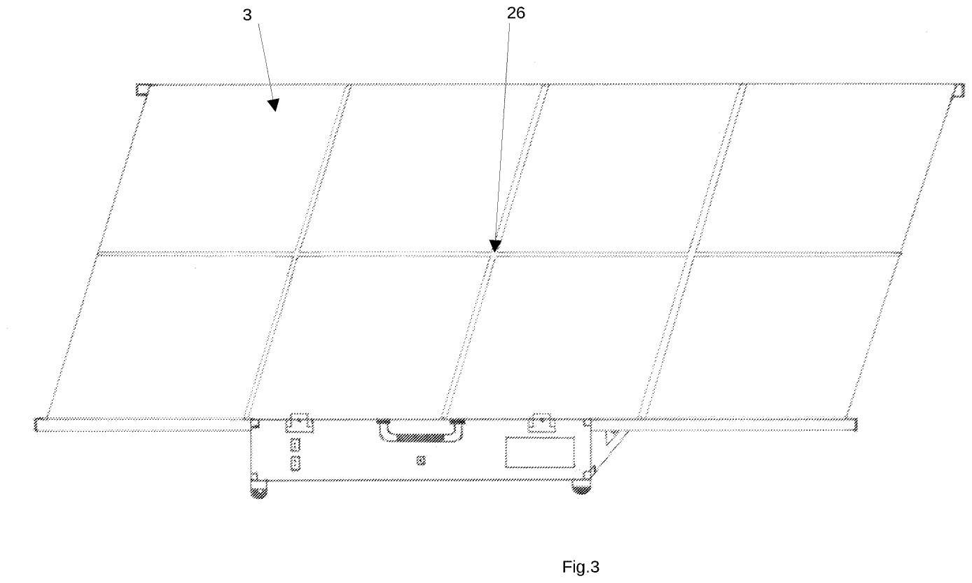

FIG. 3 shows the portable energy production and storage device 1 in a configuration with the folding panels 3 correctly positioned on the supports, brackets, and guides. In fact, once the connection between extractable and/or removable supports 15, brackets 13 and guides 12 has been set up, said panels can be unfolded and supported on the support surface, finding a planar positioning to be exposed to the sun. FIG. 3 also shows a photodiode 26 suitable for measuring the incident solar radiation on the exposure plane of said panels for the purposes already illustrated above, or to determine the best position of the panels with respect to the sun, said photodiode may be positioned in any position suitable for the purpose.

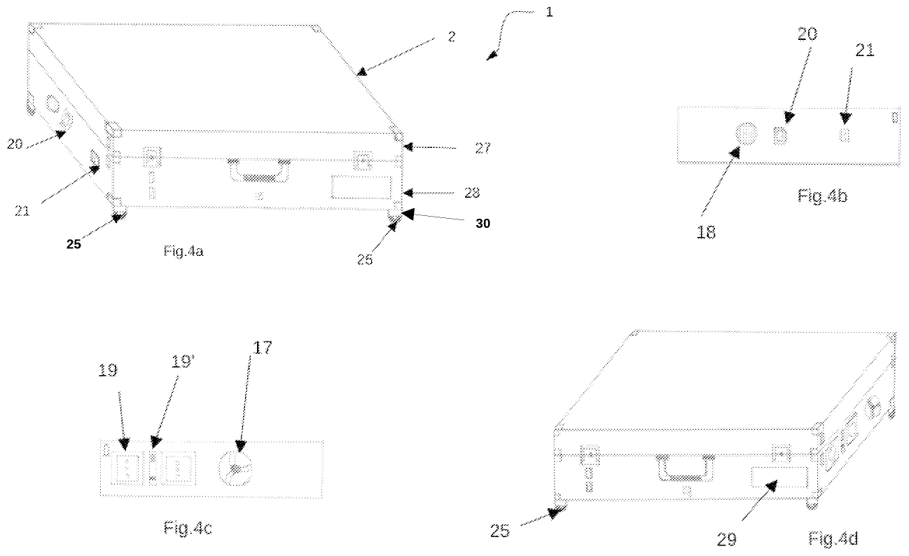

In FIGS. 4a, 4b, 4c, 4d further views of the portable energy production and storage device 1 are visible: on the outer lateral surfaces of the container 2 are made: a display 29 to show some operating parameters of the device 1, then there are alternating current sockets 19 for AC charging, USB ports 19′ and inverter power button, a charging port 20 for charging batteries from non-photovoltaic sources, a common port 21 that will allow one or more devices 1 or various types of charging/power cables to be connected to each other but also to the cigarette lighter socket of the car, to parallel or series connection cables of external batteries. In an innovative way, in fact, with a simple connection by means of said common port 21, it will be possible to expand the electrical capacity of the single portable energy production and storage device so as to be able to increase its applications of use or being able to connect to further portable energy production and storage devices to increase the electrical power of production and storage and/or to connect to the cigarette lighter socket of the car, to parallel or series connection cables of external batteries.

Then there are air vents 18 and fans 17 to ensure the correct cooling of the components contained in the container 2.

In a variant embodiment, not shown here, the container 2 can be equipped with gaskets and plugs to be able to seal it, when closed, in a watertight manner, this also making it suitable for transport in humid or wet environments.

Additionally, by means of the control board and an external app that can be connected to said board, it will be possible to account for the energy produced and consumed from renewable sources (i.e. by accounting for the incoming one from the SCC and the outgoing one from the inverter), this energy produced in a virtuous way can be transformed into digital credits (tokens) that will represent the amount of CO2 saved and not released into the atmosphere; said token can be exchanged on the blockchain to produce a return functional to the amount of renewable energy produced.

In a still preferred embodiment said device will use a printed circuit board (PCB) containing all the aforementioned components of the board and others arranged in series arranged on a single board. The related improvements are tangible in terms of weight and volume, greatly reducing the number of mounting surfaces, wiring and the difficulty in mounting the device.

It is still added: one of the reasons why it is difficult to obtain a waterproof certification is the presence of surfaces that communicate with the outside.

In a preferred embodiment, to have the waterproof certificate, an aluminum sink is included, arranged on the lower (or even upper) part of the device in such a way that it exchanges heat with the outside, while the electronics whose heat is to be dissipated are mounted on the inside of the device, consequently, the bottom of the case includes an aluminum thermal well in addition to the present bottom which will then be removed or drilled in some parts, thanks to this it will be possible to eliminate the fans (17) communicating with the outside, while there will be an internal recirculation fan to standardize the temperature inside the device, considering that, in the case of the generator, the presence of the fan (17) for cooling the device, communicating between the inside and the outside, represents a possible water inlet, this is therefore eliminated.

It is therefore evident that the present invention allows to improve the state of the art and brings important innovations in the field, it should be noted that variations in materials used, number of panels, dimensions of the container, number and type of external sockets, number of wheels and type, position of the various elements included in the container are all possible variants of the present invention and protected by it as better defined by the appended claims.

1. A portable energy production and storage device (1) comprising at least one container (2) comprising at least one inverter (6), at least one solar charge regulator

(8) at least one battery (4) and characterized in that it further comprises within said container (2), photovoltaic panels (3) for recharging said batteries (4), guides (12), brackets (13) and/or extractable and/or removable supports (15) to house said panels (3) once extracted from said container (2) to be exposed to the sun.

2. The portable energy production and storage device (1) according to claim 1, which further comprise inside said container (2) at least one control board (9) and outside it in a lower part of the container motorized wheels (25), at least one traction motor (30) on at least one of said wheels.

3. The portable energy production and storage device (1) according to the preceding claims, wherein said control board (9) being connected to said at least one inverter (6) and to at least one solar charge regulator (8) and to at least one battery (4) to monitor at least the electricity production parameters, said control board (9) being further connected to at least one traction motor (30) to be able to operate said traction motor in order to move said container in a position of maximum production of photovoltaic energy or keeping the photovoltaic panels always facing the sun.

4. The portable energy production and storage device (1) according to the preceding claims, wherein said control board (9) further comprising a radio interface (40) to connect via technology e.g. WIFI, Bluetooth, BLE, LTE, GSM, satellite to a terminal such as a smartphone for monitoring said electrical production parameters.

5. The portable energy production and storage device (1) according to the preceding claims, wherein said container (2) comprises at least one video camera (14) facing its outer surface, said video camera (14) being connected to said control board (9) to be able to visually monitor the place where said portable energy production and storage device (1) is positioned.

6. The portable energy production and storage device (1) according to the preceding claims, wherein said control board (9) further comprises GPS localization means (41) to be able to send the position of said container (2) also to a remote user.

7. The portable energy production and storage device (1) according to the preceding claims, wherein said container (2) comprising in an external side at least one common port (21), for connecting to further portable energy production and storage devices to increase the electric power of production and storage and/or to connect to a cigarette lighter socket of a car, to parallel or series connection cables of external batteries.

8. The portable energy production and storage device (1) according to the preceding claims, wherein said container (2) further comprises gaskets and plugs suitable for sealing the openings towards the outside in order to be able to make it resistant to water during a phase of transport or operation in the rain.

9. The portable energy production and storage device (1) according to the preceding claims, wherein said control board (9) comprising a meter for the energy produced which can be 2 converted into a credit proportional to the quantity of CO2 saved.

10. The portable energy production and storage device (1) according to the preceding claims, wherein at least one display (29) is further present on the outer lateral surfaces of the container (2) to show some operating parameters of the device 1, plugs for alternating current (19) for supplying AC loads, USB ports (19′) and inverter power button, a charging port (20) for charging batteries from non-photovoltaic sources, and more air vents (18) and fans (17) to ensure the correct cooling of the components contained in the container (2) and/or at least one photodiode (26) suitable for measuring the incident solar radiation on the exposure plane of said panels to determine the best position of the panels with respect to the sun.

11. The portable energy production and storage device (1) according to the preceding claims, wherein, in a preferred embodiment, to have the waterproof certificate an aluminum sink is included, arranged on the lower (or even upper) part of the device in such a way that it exchanges heat with the outside, while on the inside of the same electronics are mounted whose heat is to be dissipated, consequently, the bottom of the case comprises an aluminum thermal well in addition to the present bottom which will then be removed or perforated in some parts, thanks to this it will be possible to eliminate the fans (17) communicating with the outside, while there will be an internal recirculation fan to uniform the temperature inside the device, considering that the presence of the fan (17) for cooling the device, communicating between the inside and the outside, represents a possible water inlet, this is therefore eliminated.

12. A solar tracking system according to the device referred to in the preceding claims, wherein the solar tracking functionality is carried out by means of said control board (9), which can be assimilated, at least in part, to a microcontroller, it will read the instantaneous current values produced by the photovoltaic panels (3) and/or the brightness detected by the photodiode (26) after which it will move the container by means of activation of the wheels (25) and motors (30), the photovoltaic panels (3) are solid to the container in their configuration, the movement of the container (2) will continue until the current produced by the panels or the brightness values recorded by the photodiode are maximized, this happens as follows, always operated by the board (9):
photodiode reading and/or current input to the SCC (reading 1) by the card;
clockwise rotation (boreal hemisphere) of X degrees;
photodiode reading (26) and/or current input to the SCC (reading 2);
if (reading 2 is>reading 1), rotate again by (X) degrees and reading 3;
if (reading 3>reading 2), rotate again until (reading n<reading n-1);
return to previous position and STOP;
wait (15-30) minutes and repeat the cycle, this in a completely advantageous way providing maximum charging efficiency derived from the exposure of the solar panels.

13. The solar tracking system according to the device according to the preceding claims, wherein the solar tracking functionality is carried out by means of said board (9) in a second way represented by the possibility of setting a programmed tracking substantially by programming the microcontroller to operate the electric motor(s) every (time z) so as to rotate the portable energy production and storage device (1) by (y) degrees towards the west for example by promoting a rotation of the portable energy production and storage device (1) by (3° every 15) minutes in a clockwise direction.
